(19) United States
(12) Patent Application Publication
(10) Pub. No.: US 2006/0282878 A1
(43) Pub. Date: Dec. 14, 2006

(54) Expression of packet processing policies using file processing rules

(76) Inventors: James C. Stanley, Portland, OR (US); Andrew D. Henroid, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/153,753

(22) Filed: Jun. 14, 2005

(51) Int. Cl. H04L 9/00

(52) U.S. Cl. 726/1

(57) ABSTRACT

Methods and apparatuses for distribution of rules using file-level Web-based protocols. The rules are mapped to a packet processing rules having a different outcome schema and applied by a client device.

### TECHNICAL FIELD

Embodiments of the invention relate to techniques for communicating packet processing policies. More particularly, embodiments of the invention relate to techniques for communicating, using file processing level rule protocols, policies to be used for packet processing.

### BACKGROUND

Packet processing policies (hereinafter “policies” for brevity) may be used by or with networked electronic devices for many reasons. For example, policies may be used to enforce isolation of an electronic device infected with malware (e.g., virus, worm, Trojan horse) to prevent spread of the malware. Other policies may also be enforced.

Policies are generally expressed as one or more rules that are applied to the packet being processed. Currently, there exist many different formats for expressing rules. Typically, each electronic device is configured either manually or through use of proprietary rule communication protocols. As a result, distribution of packet processing rules can be cumbersome and/or inefficient.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is one embodiment of a network including a server to provide rules and a client to apply rules.

FIG. 2 is a block diagram of a conceptual structure of one embodiment of an overall policy set combining strategy.

FIG. 3 is a block diagram of one embodiment of an electronic system.

FIG. 4 is a flow diagram of one embodiment of a technique for receiving and applying packet processing rules.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Described herein are embodiments of a system that may act as a dynamic firewall on a client device that can block or pass network (e.g., Ethernet) packets based on rules expressed by various entities (e.g., network administrator, system user). In one embodiment, distribution of rules may be accomplished using a pre-existing standard (e.g., Extensible Access Control Markup Language, or XACML) that may be capable of expressing a set of rules. In one embodiment, XACML, designed for file-level rules, may be used to communicate packet-level rules to be enforced by client devices.

In one embodiment, the dynamic firewall is provided by a device driver that enforces the rules. Because a large number of systems (e.g., desktop computers, laptop computers, palmtop computers) may be recipients of the rules, use of a pre-existing standard may provide an efficient technique for distribution of packet processing rules. One version of XACML is described in “eXtensible Access Control Markup Language, Version 2.0” published March 2005. Other rule-based standards may also be used.

In one embodiment, the result of rule-based analysis may be whether a specific IP address and/or port combination is allowed or rejected. In one embodiment, a rule may be defined as owned by an administrator (e.g., IT or system administrator) or owned by the device user (e.g., computer system user). In one embodiment, a rule may consist of, for example, a Universal Resource Indicator (URI), which may include wildcard characters, an ownership indication and an indication whether the URI should be rejected, allowed or accepted.

In one embodiment, because rules may correspond to multiple owners (e.g., administrator and user), rule management may utilize multiple rule sets. Rule evaluation may define merging of results based on the various rule sets. For example, the administrator rule set may take precedence over a user rule set. That is, packets that are blocked based on the administrator rule set may be blocked regardless of the rules in the user rule set and packets that are accepted by the administrator rule set cannot be blocked by rules in the user rule set. Further, policies within a rule set may take precedence over other policies within the rule set.

In one embodiment, rule evaluation supports a distinction between allowing and accepting a URL. In one embodiment, when a rule results in accepting a URL, the associated packet is blocked if there is a rule in any rule set that blocks access. That is, an accepting rule is a stronger condition than an allowing rule. For example, if an administrator rule accepts a packet, the packet is passed through the network driver regardless of rules in the user rule set that may block the packet. If an administrator rule allows a packet, a user rule may still block the packet.

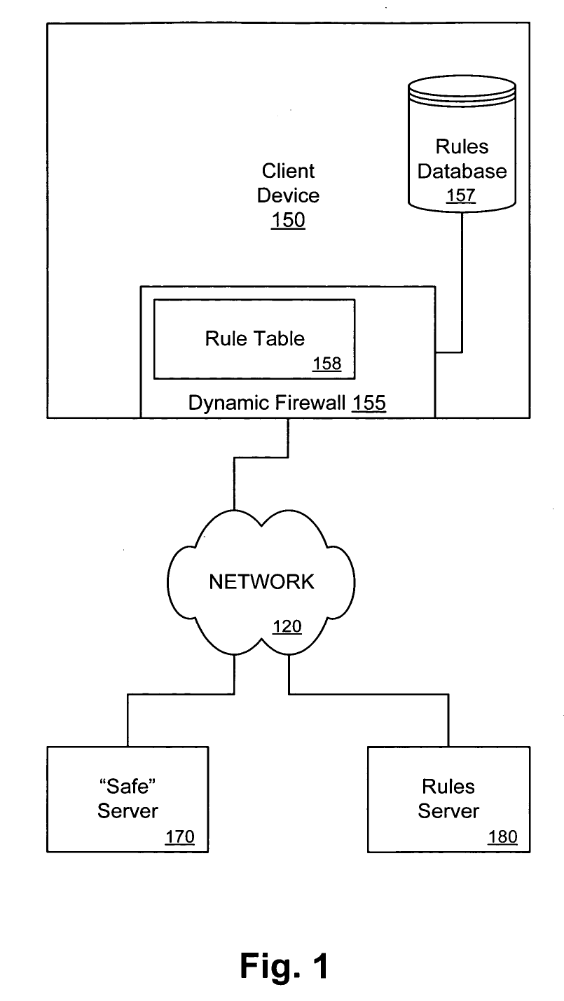

FIG. 1 is one embodiment of a network including a server to provide rules and a client to apply rules. The example of FIG. 1 includes a single client device, a single “safe” server and a single rules server; however, any number of these devices may be included in an example that provides packet processing as described herein.

Network 120 may be any type of network that operates to interconnect multiple electronic devices. Network 120 may include wired and/or wireless links using any communication protocol known in the art. In one embodiment, rules server 180 operates to provide rules that define a packet processing policy to multiple devices interconnected by network 120.

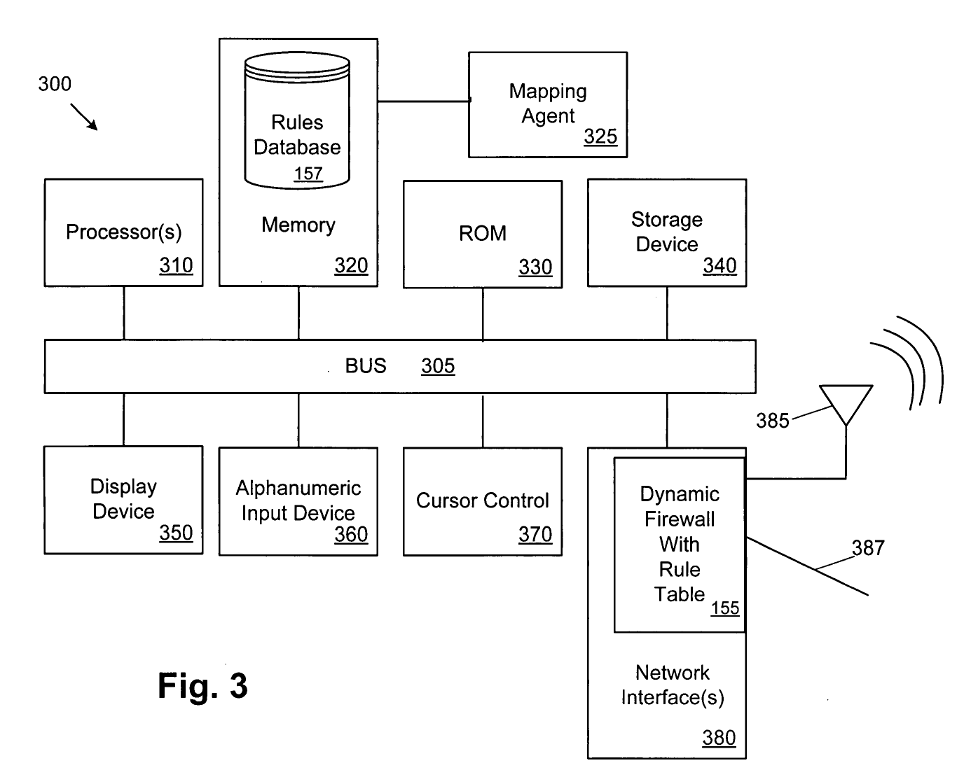

Client device 150 is intended to represent a broad range of electronic devices that may be coupled with network 120, including any type of electronic device that may apply a packet processing policy. Client device 150 may include components not illustrated in FIG. 1, for example, one or more processors, input and/or output devices, memory, etc. an example client device is illustrated in more detail with respect to FIG. 3.

In one embodiment, client device 150 sends and receives packets to and from network 120 through dynamic firewall 155 that may operate to block or allow packets according to a packet processing policy that may be defined by one or more sets of rules. The rule sets may be stored by rules database 157. “Safe” server 170 is an optional server that may be allowed to communicate with client device when all other devices are blocked, for example, as the result of a malware infection.

In one embodiment, rules database 157 may store the XACML-formatted rules as received from rules server 180. The XACML-formatted rules may be translated to a format that may be more suitable for packet processing. In one embodiment, dynamic firewall 155 includes rule table 158 that may store packet processing rules. Rule table 158 may store rules in any format and should not be limited to a table format. Techniques for mapping of XACML-formatted rules to packet processing rules are described in greater detail below.

As described in greater detail below, rules from rules server 180 may be transmitted to client device 150 using a Web standard rule structure such as, for example, XACML. Use of standard rule structures may allow the rule handling architecture to send rules to a client device as well as query a client device to determine what rules are in force. Use of standard rule structures may also facilitate addition and/or removal of rules and rule set evaluation. In an embodiment using XACML, the standard that defines the rule structure may not apply to the techniques by which rules are sent to the client or queried, nor to the ways that rules are updated on the client.

In one embodiment, the rule evaluation architecture may support a distinction between allowing access to an address and accepting access to the address. When a rule accepts access, packets from the address may be allowed through the network driver if there is no rule in the same rule set that blocks the address. When a rule allows access, the packet may be blocked if there is a rule in any rule set that blocks the access. Thus, an accepting rule is a stronger condition than an allowing rule.

The distinction between accepting and allowing may be used to support multiple rule sets having different priorities, for example, a network administrator rule set and a user rule set. For example, if a network administrator rule set accepts a packet (and no network administrator rules reject the packet), the packet may be passed through the network driver regardless of rules in the user rule set that may block access (if the network administrator rules are processed first). If a network administrator rule allows a packet, a user rule may still block the packet. That is, the allow condition may require evaluation of all rules to determine whether the access is completed.

Table 1 below corresponds to one embodiment of rule evaluation using the accept/deny paradigm of XACML with two rule sets. Entries in Table 1 indicate that a rule set has a rule that accepts a packet (A), rejects the packet (D), does not have an applicable rule (NA), or does not care (--). In one embodiment, the effects of XACML error conditions in evaluating rules are not considered.

TABLE 1
Rule Evaluation

| Admin-Accept | Admin-Other | User-Accept | User-Other | Result |
|---|---|---|---|---|
| A | NA | — | — | A |
| A | D | — | — | D |
| NA | D | — | — | D |
| NA | A | A | NA | A |
| NA | A | NA | A | A |
| NA | A | A | D | D |
| NA | A | NA | D | D |
| NA | NA | A | NA | A |
| NA | NA | A | D | D |
| NA | NA | NA | NA | No result |

In one embodiment, if no rule applies, a default rule may be applies to reject the packet.

The XACML standards define protocols for expression of rules and sets of rules as well as protocols to combine evaluations of rules and rule sets to arrive at an overall accept/block decision. The target of the XACML rules as defined by the XACML standards are generally Universal Resource Indicators (URIs), which may be, for example, an IP address and port number. In contrast, the techniques described herein allow packet-processing rules to be communicated using Web-based standards (e.g., XACML). However, in order to implement XACML (or any other Web-based rules standard), the rule expressions may be required to be mapped to packet processing rule structures. In the examples that follow, XACML expressions are translated to packet processing rules; however, other types of rule expressions may be used in a similar manner.

In one embodiment, the data of interest in a packet to be processed may be the URI (e.g., IP address and port); however, additional and/or different data may also be processed. In one embodiment, URIs corresponding to rules may be stored in an Extensible Markup Language (XML) record in a database of URIs. XACML rules may then refer to elements of the database records, which may be corresponding URIs and/or other information in the records.

In one embodiment, only URIs are used for packet processing and, in such an embodiment, it may be more efficient in terms of XACML primitives to represent an incoming packet as a reference to an XACML resource. The XACML resource-id attribute may provide the URI information to which packet processing rules may be applied. In one embodiment, the following XACML context request may be used:

<?xml version=“1.0” encoding=“UTF-8”?>
<Request xmlns=“urn:oasis:xacml:core:2.0:context:schema:cd”
xmlns:xsi=“http://www.w3.org/2001/XMLSchema-instance”
xsi:schemaLocation=“urn:oasis:xacml:core:2.0:context:schema:cd
http://docs.oasis-open.org/xacml/xacml-core-2.0-context-schema-cd.xsd”>

<Subject/>
<Resource>

<Attribute

AttributeId=“urn:oasis:names:tc:xacml:1.0:resource:resource-id”
DataType=“http://www.w3.org/2001/XMLSchema#anyURI”>

<AttributeValue>//134.134.19.245:1080</AttributeValue>

</Attribute>

</Resource>
<Action/>
<Environment/>

</Request>

For this request the subject, action and environment elements are empty because the action is implicit (read/write access is to be granted as a result of the request). The resource element of the request specifies the desired URI using the predefined resource-id attribute of the resource. This specifies the data for packet processing purposes by using XACML primitives.

Defining an incoming request this way may also help define the target of rules, policies and policy sets. The target has only a <resources> element, corresponding to the URI (or range of URIs) required. In one embodiment, the syntax defining a target in these terms may be:

<Target>

<Resources>

<Resource>

<ResourceMatch

MatchId=“urn:oasis:names:tc:xacml:1.0:function:regexp-uri-match”>

<AttributeValue

DataType=“http://www.w3.org/2001/XMLSchema#anyURI”>//www.intel.co
m/*</AttributeValue>

<ResourceAttributeDesignator

AttributeId=“urn:oasis:names:tc:xacml:2.0:resource:resource-id”
DataType=“http://www.w3.org/2001/XMLSchema#anyURI”/>

</ResourceMatch>

</Resource>

</Resources>

This example target specifies a match to a resource with the id “. . . intel.com/*”. The id has a data type “anyURI.” The match is to be performed using the regexp-uri-match function as defined by the XQuery specification.

XQuery is a specification for a query language that allows extraction of information from XML files or data. XQuery is defined by documents available from the World Wide Web Consortium (W3C) and makes use of XPath, a language that describes techniques to locate and process items in XML documents.

An example rule using the example target is shown below. In one embodiment, a rule must be wrapped in a policy for use with XACML. In one embodiment, the client device simplifies rules received according to XACML protocols for local implementation.

<Policy xmlns=“urn:oasis:xacml:core:2.0:policy:schema:cd” xmlns:xacml-
context=“urn:oasis:xacml:core:2.0:context:schema:cd”
xmlns:xsi=“http://www.w3.org/2001/XMLSchema-instance”
xsi:schemaLocation=“urn:oasis:xacml:core:2.0:policy:schema:cd
http://docs.oasis-open.org/xacml/xacml-core-2.0-context-schema-cd.xsd”
PolicyId=“urn:OnConnect:user:policyid:1”
RuleCombiningAlgId=“urn:oasis:names:tc:xacml:1.0:rule-combining-
algorithm:deny-overrides”>

<Target/>
<Rule RuleId=“urn:OnConnect:user:ruleid:1” Effect=“Permit”>

<Description>Allow access to URIs of form

//www.intel.com/*</Description>

<Target>

<Resources>

<Resource>

<ResourceMatch

MatchId=“urn:oasis:names:tc:xacml:1.0:function:regexp-uri-match”>

<AttributeValue

DataType=“http://www.w3.org/2001/XMLSchema#anyURI”>//www.intel.co
m/*</AttributeValue>

<ResourceAttributeDesignator

AttributeId=“urn:oasis:names:tc:xacml:2.0:resource:resource-id”
DataType=“http://www.w3.org/2001/XMLSchema#anyURI”/>

</ResourceMatch>

</Resource>

</Resources>

</Target>

</Rule>

</Policy>

The rule includes the target defined previously, with an effect of “permit” to allow access to any URI that matches the target URI. The policy contains the rule, with the “deny-overrides” rule combining described above (any rule in the policy that evaluates to “deny” will cause access to be denied).

In one embodiment, the two-outcome (accept/reject) XACML rules are mapped to a three-outcome (accept, allow, reject) packet processing procedure. As discussed above, the difference between “accept” and “allow” is that when a rule evaluates to “accept,” the packet is enabled if there is no rule in the current rule set that evaluates to “reject.” This suggests that there may be separate rule sets (policies or policy sets, in XACML terms) for an administrator (network or local) and for a user. Because XACML rules have only “accept” and “reject” results, a mechanism may be needed to distinguish between “allow” and “accept” rules. In one embodiment, this may be accomplished by grouping “accept” rules into a separate policy and using a policy combination algorithm to accomplish the mapping from two outcomes to three outcomes. This technique may be used in general for any number of non-standard rule evaluation outcomes.

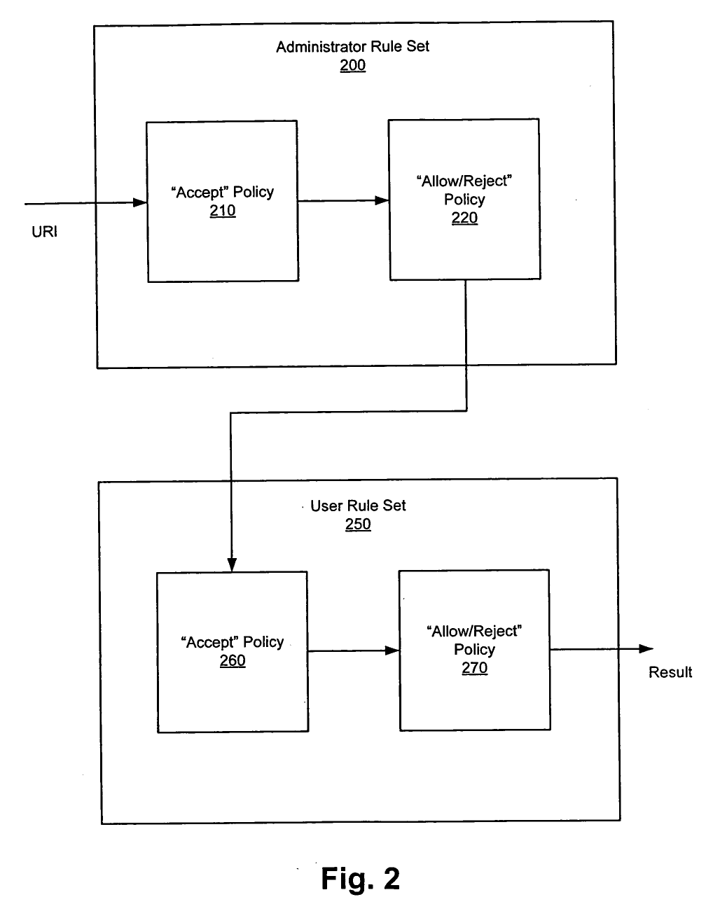

FIG. 2 is a block diagram of a conceptual structure of one embodiment of an overall rule set combining strategy. The example of FIG. 2 includes two rule sets; however, any number of rule sets may be supported in a similar manner.

In the example of FIG. 2, administrator rule set 200 is evaluated first followed by user rule set 250. Within the rule sets the accept policies (210 and 260) are processed before the allow/reject policies (220 and 270) of the respective rule sets. The accept policies 210, 260 correspond to rules that, when evaluated, determine whether a packet should be accepted. Similarly, the allow/reject policies 220, 270 correspond to rules that, when evaluated, determine whether a packet should be allowed or rejected. Because of the accept-allow distinction described above, the ordering of the rule evaluation illustrated in FIG. 2 supports mapping of two-outcome rule protocols to be used to communicate three or more outcome rules.

In one embodiment a policy combining strategy may be used to combine the outcomes of the rule set analysis to map XACML rule analysis to packet processing techniques. In one embodiment, for the packet processing rules, an administrator “accept” may be overridden only by a “deny” from the administrator rule set. An administrator “allow” may be overridden by a “deny” from the user rule set. The combining strategy may evaluate the results of related pairs of policies (e.g., the “accept” and the “allow/reject”) to arrive at a result. Table 2 outlines results of one embodiment of a policy combining strategy for the administrator rule set. Similar results would be provided by the user rule set.

TABLE 2
Dual-Scope Combination

| Administrator- | Administrator- | |
|---|---|---|
| Accept | Allow/Reject | Result |
| A | NA | A |
| A | D | D |
| NA | D | D |
| NA | A | Defer |
| NA | NA | Defer |

The example of Table 2, in the case that the administrator rules generate either a simple “allow” or are not applicable, the decision is deferred to the next rule set (e.g., user rule set). If there are no further rule sets, the outcome may be either “accept” or “NA.” The following pseudocode describes one embodiment of a combining strategy.

Decision dualScopePolicyCombiningStrategy ( Policy policy[] )
{

Decision acceptDecision;
Decision otherDecision;
// consider policies two by two
for ( i = 0; i < number of policies in policy[]; i += 2 )
{

| | |
|---|---|
| acceptDecision = evaluate( policy[i] ); | // ‘accept’ rules for IT |

// or user, ...

| | |
|---|---|
| otherDecision = evaluate( policy[i+1] ); | // ‘allow/reject’ rules |

//for IT or user, ...

// implement decision table for this pair of policies
// if the outcome is ‘defer’, consider next pair of policies
// in order
if ( acceptDecision == ‘accept’ && otherDecision == ‘not applicable’

)

return ‘accept’;

else if ( otherDecision == ‘deny’ )

return ‘deny’;

else if ( acceptDecision == ‘not applicable’ &&

| otherDecision == ‘not applicable’ ) | |
|---|---|
| continue; | // defer to next policy pair |

else if ( acceptDecision == ‘not applicable’ &&

| otherDecision == ‘accept’ ) | |
|---|---|
| continue; | // defer to next policy pair |

else

| | |
|---|---|
| return ‘indeterminate’; | // error return |

}

// final policy pair had a ‘defer’ decision; since there are no rules
// to which to defer, use result from final pair of policies.
// this will be either ‘not applicable’ or ‘accept’, depending on the
// state of the final ‘other’ policy.

return otherDecision;

}

FIG. 3 is a block diagram of one embodiment of an electronic system. The electronic system illustrated in FIG. 3 is intended to represent a range of electronic systems (either wired or wireless) including, for example, desktop computer systems, laptop computer systems, cellular telephones, personal digital assistants (PDAs) including cellular-enabled PDAs and “smart” phones, set top boxes. Alternative electronic systems may include more, fewer and/or different components.

Electronic system 300 includes bus 305 or other communication device to communicate information, and processor 310 coupled to bus 305 that may process information. While electronic system 300 is illustrated with a single processor, electronic system 300 may include multiple processors and/or co-processors. Electronic system 300 further may include random access memory (RAM) or other dynamic storage device 320 (referred to as main memory), coupled to bus 305 and may store information and instructions that may be executed by processor 310. Memory 320 may also be used to store temporary variables or other intermediate information during execution of instructions by processor 310. In one embodiment, memory 320 may include rules database 157. In alternate embodiments, rules database 157 may be stored by other components, or rules database 157 may be split between multiple components.

In one embodiment, electronic system 300 may include mapping agent 325 that may provide sufficient functionality to perform the mapping of XACML rules and policies to packet processing rules as described above. Mapping agent 325 may be implemented as software, hardware, firmware or any combination thereof.

Electronic system 300 may also include read only memory (ROM) and/or other static storage device 330 coupled to bus 305 that may store static information and instructions for processor 310. Data storage device 340 may be coupled to bus 305 to store information and instructions. Data storage device 340 such as a magnetic disk or optical disc and corresponding drive may be coupled to electronic system 300.

Electronic system 300 may also be coupled via bus 305 to display device 350, such as a cathode ray tube (CRT) or liquid crystal display (LCD), to display information to a user. Alphanumeric input device 360, including alphanumeric and other keys, may be coupled to bus 305 to communicate information and command selections to processor 310. Another type of user input device is cursor control 370, such as a mouse, a trackball, or cursor direction keys to communicate direction information and command selections to processor 310 and to control cursor movement on display 350.

Electronic system 300 further may include network interface(s) 380 to provide access to a network, such as a local area network. In one embodiment, network interface(s) 380 may include dynamic firewall 155 and the rule table discussed above. Network interface(s) 380 may include, for example, a wireless network interface having antenna 385, which may represent one or more antenna(e). Network interface(s) 380 may also include, for example, a wired network interface to communicate with remote devices via network cable 387, which may be, for example, an Ethernet cable, a coaxial cable, a fiber optic cable, a serial cable, or a parallel cable.

In one embodiment, network interface(s) 380 may provide access to a wireless local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 380 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

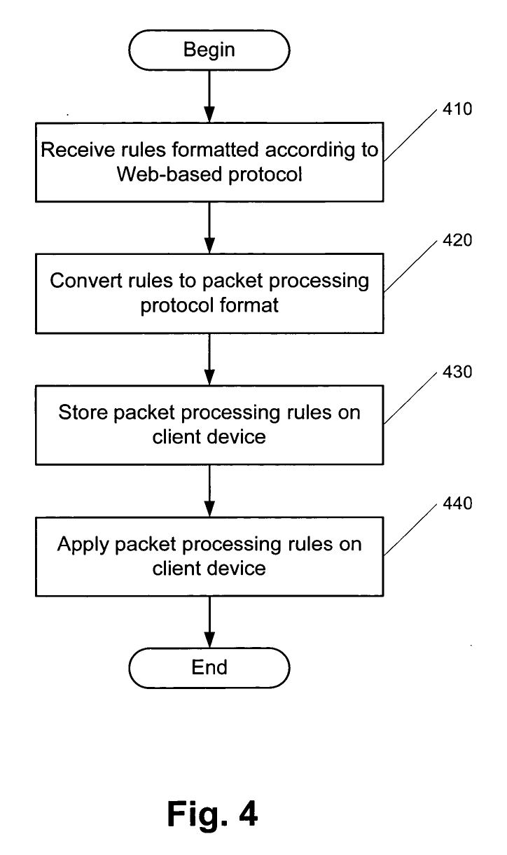

FIG. 4 is a flow diagram of one embodiment of a technique for receiving and applying packet processing rules. One or more rules may be received from a remote source according to a Web-based protocol, 410. In one embodiment, one or more rules may be received from a rules server using the XACML protocols. One or more rules may also be received from a user of an electronic system according to input provided using XACML protocols and standards.

The received rules may be converted to a packet processing format, 420. In one embodiment, two-outcome XACML rules may be mapped, as described above, to a three-outcome packet processing rule set. More than three outcomes may also be supported for the packet processing rule set. The mapped rule set may be stored by a client device, 430, for example, in a rule table that may be maintained by a component to provide firewall functionality. The packet processing rules may be applied by the client device, 440.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a packet processing policy from a server device by a client device using Web-standard access control rules having a first number of possible outcomes;
converting the rules to a packet processing rule format having a second number of possible outcomes to apply the packet processing policy at the client device; and
applying the packet processing rules by the client device.

2. The method of claim 1 wherein the Web-standard access control rules comprise rules defined according to an Extensible Access Control Markup Language (XACML) standard.

3. The method of claim 1 wherein the second number of possible outcomes is greater than the first number of possible outcomes.

4. The method of claim 3 wherein the first number of possible outcomes is two.

5. The method of claim 4 wherein the two possible outcomes correspond to accept and deny.

6. The method of claim 3 wherein the second number of possible outcomes is three.

7. The method of claim 6 wherein the three possible outcomes correspond to accept, allow and deny.

8. The method of claim 1 wherein policies defined by an administrator have a higher priority than policies defined by a client user.

9. An article comprising a computer-readable medium having stored thereon instructions that, when executed, cause one or more processors to:
receive a packet processing policy from a server device by a client device using Web-standard access control rules having a first number of possible outcomes;
convert the rules to a packet processing rule format having a second number of possible outcomes to apply the packet processing policy at the client device; and
apply the packet processing rules by the client device.

10. The article of claim 9 wherein the Web-standard access control rules comprise rules defined according to an Extensible Access Control Markup Language (XACML) standard.

11. The article of claim 9 wherein the second number of possible outcomes is greater than the first number of possible outcomes.

12. The article of claim 11 wherein the first number of possible outcomes is two.

13. The article of claim 12 wherein the two possible outcomes correspond to accept and deny.

14. The article of claim 11 wherein the second number of possible outcomes is three.

15. The article of claim 14 wherein the three possible outcomes correspond to accept, allow and deny.

16. The article of claim 9 wherein policies defined by an administrator have a higher priority than policies defined by a client user.

17. An apparatus comprising:
a network interface having a packet processing rules table;
a rules database coupled with the network interface to store a set of rules defined according to a Web-based standard having a first number of potential outcomes;
a mapping agent coupled with the rules database to translate rules from the rules database to set of packet processing rules having a second number of potential outcomes to be stored in the packet processing rules table; and
a firewall agent within the network interface coupled with the packet processing rules table to apply the packet processing rules.

18. The apparatus of claim 17 wherein the Web-based rules comprise rules defined according to an Extensible Access Control Markup Language (XACML) standard.

19. The apparatus of claim 17 wherein the second number of possible outcomes is greater than the first number of possible outcomes.

20. The apparatus of claim 19 wherein the first number of possible outcomes is two.

21. The apparatus of claim 20 wherein the two possible outcomes correspond to accept and deny.

22. The apparatus of claim 17 wherein the second number of possible outcomes is three.

23. The apparatus of claim 22 wherein the three possible outcomes correspond to accept, allow and deny.

24. A system comprising:
a network interface having a packet processing rules table;
a network cable connected to the network interface;
a rules database coupled with the network interface to store a set of rules defined according to a Web-based standard having a first number of potential outcomes;
a mapping agent coupled with the rules database to translate rules from the rules database to set of packet processing rules having a second number of potential outcomes to be stored in the packet processing rules table; and
a firewall agent within the network interface coupled with the packet processing rules table to apply the packet processing rules.

25. The system of claim 24 wherein the Web-based rules comprise rules defined according to an Extensible Access Control Markup Language (XACML) standard.

26. The system of claim 24 wherein the second number of possible outcomes is greater than the first number of possible outcomes.

27. The system of claim 26 wherein the first number of possible outcomes is two.

28. The system of claim 27 wherein the two possible outcomes correspond to accept and deny.

29. The system of claim 24 wherein the second number of possible outcomes is three.

30. The system of claim 29 wherein the three possible outcomes correspond to accept, allow and deny.
